(19) United States
(12) Patent Application Publication
(10) Pub. No.: US 2014/0129484 A1
(43) Pub. Date: May 8, 2014

(54) METHOD OF MARKETING PROTEIN HYDROLYSATE FOR HIGH ENERGY SENSATION

(71) Applicant: DSM IP ASSETS B.V., Heerlen (NL)

(72) Inventors: Regina GORALCZYK, Basel (CH); Hasan Mohajeri, Basel (CH); Jonas Wittwer-Schegg, Basel (CH)

(73) Assignee: DSM IP ASSETS B.V., Heerlen (NL)

(21) Appl. No.: 14/067,224

(22) Filed: Oct. 30, 2013

Related U.S. Application Data
(60) Provisional application No. 61/721,527, filed on Nov. 2, 2012.

(51) Int. Cl. G06Q 90/00

(52) U.S. Cl. CPC G06Q 90/00
USPC 705/500

(57) ABSTRACT

Accordingly this invention relates to a method of increasing a feeling of energy in a healthy adult comprising administering a dosage form comprising a low dose of a Trp-containing di- and/or tri-peptide mixture characterized in that the peptide composition is an egg lysozyme hydrolysate with a Trp/LNAA ratio greater than 0.15 and which provides 30- to 50 mg Trp per dose. This dosage form should be administered multiple times per day for an extended period of time, such that the person receives 60-200 mg Trp per day.

### BRIEF DESCRIPTION OF THE INVENTION

This invention relates to a method of marketing a hen's egg lysozyme hydrolysate containing di- and tri-peptides which contain tryptophan (TRP) for pharmaceutical, nutraceuticals or food supplements. The method includes providing a kit comprising multiple low dose forms of the hydrolysate, and information regarding benefits obtainable by ingesting the hydrolysate, including the sensation of being energized. The method optionally includes the steps of advising a potential consumer of the benefits of the TRP-containing hydrolysate, and the advantages of various dose forms.

### BACKGROUND OF THE INVENTION

In recent years, a method has been developed to enhance tryptophan “Trp” availability to brain, and so potentially serotonin function, by administering TRP-rich dietary proteins/hydrolysates. These include the whey protein alpha-lactalbumin, and casein hydrolysate. Since the Trp present in these proteins/hydrolysates competes with Large Neutral Amino Acids (LNAAs which are tyrosine, phenylalanine, leucine, isoleucine and valine) for transport across the blood-brain barrier, a high Trp/LNAA ratio is desired, and this ratio is difficult to achieve with these protein/hydrolysates.

DSM has developed a hen egg white lysozyme hydrolysate formulation that contains fewer competing LNAAs, and is sold under the trademark LumiVida™. LumiVida™ has recently been shown to be more effective in raising plasma TRP/LNAA ratios than either alpha-lactalbumin or L-TRP alone and 4 g LumiVida™ was still able to raise TRP/LNAA ratio when ingested together with milk protein. This hydrolysate has been described in WO 2008/052995, which is hereby incorporated by reference.

Typical dosages which are used in WO 2008/052995 are quite large (10 grams hydrolysate per liter liquid; 14 grams per 300 ml drink) as this appears to be necessary for increasing serum Trp/LNAA ratios, and ultimately increase the Trp availability to the brain. However, the peptides are rather bitter tasting. It would be desirable to have a formulation which was pleasant tasting and also provides enough Trp to the brain as to be effective.

### DETAILED DESCRIPTION OF THE INVENTION

It has been surprisingly found, in accordance with this invention that administration of Trp in the form of Trp-rich peptides at a low doses can provide enough Trp to the brain so that it is effective. This has two advantages over the prior art higher dose:
1) it can be administered in a low dose pleasantly tasting formulation, and
2) surprisingly, provide a positive feeling of increased energy when used in a low-dosage form when administered acutely, i.e. after only one administration. In addition, the feeling may also be achieved when the Trp-hydrolysate is administered chronically, i.e. over a period of time.

Accordingly this invention relates to a method of marketing a Trp-containing protein hydrolysate for increasing a feeling of energy in a healthy adult comprising administering a plurality of dosages per day comprising a low dose of a Trp-containing di- and/or tri-peptide mixture characterized in that the peptide composition is a hen's egg lysozyme hydrolysate with a Trp/LNAA ratio greater than 0.15, preferably 0.18 to 0.23; and which provides 10-70 mg Trp per dose, and preferably 20-70 mg Trp per dose and more preferably 25-60. In one preferred embodiment, 500 mg of hydrolysate contains 31-32 mg Trp per dose.

In one embodiment, the consumer is informed that the dosage may be administered acutely. This acute administration can occur as the effects are observed regardless of the Trp/LNAA ratio is prior to administration.

In another embodiment, the consumer is informed that a dosage form can be administered multiple times per day for an extended period of time, such that the person receives 10-100 mg Trp per day, preferably 25-70 mg Trp per day. In one preferred embodiment, the person receives 1 gram of hydrolysate per day, which contains a total of 62-64 mg Trp. In another preferred embodiment, the person receives 0.5 grams of Trp-hydrolysate per day, which contains a total of 20-26 mg Trp.

The consumer may also be informed that the low-dose protein hydrolysate may be consumed once per day to achieve acute effects. In another preferred embodiment the protein hydrolysate is consumed 2× per day, with an interval of at least 6 hours between doses, and preferably no more than 18 hours between doses. In more preferred embodiments, the doses are consumed at approximately 12 hour intervals, such as mornings and evenings. Additional dosings per day may also be consumed if desired, such as 2-4 grams Trp-containing protein hydrolysate per day, and these dosings may be seen to have additional benefits. Dosings of greater than 10 grams Trp-containing protein hydrolysate per day are not part of this invention. Thus the dosings of this invention, for a healthy adult wishing to improve energy is enough Trp-containing protein hydrolysate to provide at least 10 mg but less than 400 mg Trp per day, preferably at least 25 mg, but less than 350 mg Trp per day.

Therefore, one aspect of this invention is a method of marketing a hen egg lysozyme hydrolysate comprising providing a kit which comprises:
a) a low dose of a hen's egg lysozyme hydrolysate comprising Trp-containing di- and/or tri-peptides (hereinafter the “Trp-containing protein hydrolysate”) characterized in that the Trp-containing protein-hydrolysate has a Trp/LNAA ratio greater than 0.15, preferably 0.18 to 0.23 and which provides 20- to 70 mg Trp per dose;
b) instructions for use which inform or advise the prospective user that the Trp-containing protein hydrolysate should be administered
   i) once per day; or
   ii) multiple times per day for an extended period of time, such that the person receives 50-100 mg Trp per day; and
c) optionally, additional information.

### BRIEF DESCRIPTION OF THE FIGURES

FIG. 1 is a graph showing the effects of treatments on overall ratings for ‘high energy’ on the final test day. Chronic LumiVida™ (0.5 g b.i.d.) treatment significantly enhanced high energy levels compared to Control (see text for details). ^{a}Means adjusted for baseline levels.

The acute effects are observed regardless of the Trp/LNAA ratio is prior to administration. Therefore, In one embodiment, the dosage may be administered acutely as a single dose, and single dosage forms may be sold separately, such as at a point-of purchase display where consumers can ingest the dosage on the go.

This dosage form may also be administered multiple times per day for an extended period of time, such that the person receives 10-100 mg Trp per day, preferably 25-70 mg Trp per day. Thus selling multiple dosings in a kit is another embodiment of this invention. In one preferred embodiment, the kit delivers to the person 1 gram of hydrolysate per day, which contains a total of 62-64 mg Trp. In another preferred embodiment, the person receives 0.5 grams of Trp-hydrolysate per day, which contains a total of 20-30 mg Trp.

Preferably the Trp-hydrolysate is consumed 2× per day, with an interval of at least 6 hours between doses, and preferably no more than 18 hours between doses. In more preferred embodiments, the doses are consumed at approximately 12 hour intervals, such as early morning and early evening. Additional dosings per day may also be consumed if desired, such as 2-4 grams hydrolysate per day, and these dosings may be seen to have additional benefits. Dosings of greater than 10 grams hydrolysate per day are not part of this invention. Thus the dosings of this invention, for a healthy adult wishing to improve energy is enough trp-containing protein hydrolysate to provide at least 25 mg but less than 400 mg Trp per day, preferably at least 30 mg, but less than 350 mg Trp per day.

In some aspects of this invention the amount of Trp-containing hydrolysate which delivers the desired amounts of Trp will be 1000 mg/day, i.e. each dose contains 500 mg Trp-hydrolysate. In another aspect the amount of Trp-hydrolysate is 400-600 mg delivered twice per day, or 800-1200 mg per day. It is also in the scope of this invention to administer somewhat larger doses of Trp-hydrolysate so that the daily dosage exceeds 1000 mg/day, but is less than 10 grams per day. Additional other doses of Trp-hydrolysate are amounts up to 2 grams but less than 4 grams per day (i.e. 1000 mg delivered 2× per day, and 2000 mg delivered 2× per day).

Another aspect of this invention is a convenient-to-use chronic dosage kit comprising multiple single dose units of an egg lysozyme hydrolysate with a Trp/LNAA ratio of greater than 0.15, preferably 0.18 to 0.23, and providing 10-50 mg Trp per dose, or 20-100 mg Trp per day. Also included in the kit are the following preferable items: A container for storing the dosage forms, information regarding how the dosages are to be used.

This invention also relates to the marketing of a low dose of Trp-containing protein hydrolysate to imparts feeling of high energy in the consumer. It also relates to the advertising of a low dose of Trp-containing hydrolysate as described to market a medicament, food supplement, or food which imparts a feeling of high energy in the consumer.

A further aspect of this invention is a kit comprising a composition comprising 400-600 mg Trp-containing hydrolysate, as described above. Another aspect of this invention is marketing a pharmaceutical, nutraceutical or food supplement where the sole active ingredient which imparts a feeling of high energy is Trp-hydrolysate. Another aspect of this invention is marketing a composition comprising at least 400 mg but less than 4000 mg of Trp-hydrolysate. Yet another aspect of this invention is marketing a composition comprising at least 400 mg but less than 2000 mg Trp-hydrolysate.

“Lumivida™” is a Trp-containing protein hydrolysate, specifically a hydrolyzed hens egg lysozyme composition which provides water soluble Trp containing peptides having a Trp/LNAA ratio of more than 0.15, and preferably between 0.18 and 0.23. It can be produced by hydrolyzing the lysozyme. Details are described WO 2008/052995, which is hereby incorporated by reference.

“Low dose” means that each dosage form of the lysozyme hydrolysate contains Trp containing di- or tri-peptides which provide 20-50 mg Trp per dose.

“Acute” means a single dosing.

“Chronic” means that the dosage forms are consumed over a period of time which is at least 19 days. Within the meaning of “chronic” are patterns of consumption which meet the definition of “substantially complied” (below).

“Substantially complied” means that, even if the person has missed a few dosages, the effects are still achieved. Specifically for a dosing regimen of 2 times per day for 19 days, a person who omits five or less non-consecutive dosings within this 19 day time period has substantially complied with the administration regime.

“Healthy” in context of this invention means that the person is in generally good health but wishes to boost their feeling of having high energy.

In previous higher dosage administration of peptides/proteins which are a source of Trp, the feeling of having high energy was not reported by participants. Here, this was seen after a single dosing. This finding was especially unexpected as the low dose formulation was not seen to raise Trp/LNAA levels significantly, and in the past, Trp was seen to encourage/enhance sleep and sleep quality.

The invention also provides a method of marketing low dose lysozyme hydrolysate comprising:
a) providing a kit to a customer, said kit comprising at least one of the following dosage forms of the Trp-hydrolysate:
   powder,
   individual dosage forms
   liquid;
   gel; or
   sorbet; and
b) providing informational material to potential consumers, wherein said informational material describes at least one of:
benefits of Trp-hydrolysate
storage instructions
recommended administration regimes
expiration dates.

One type of formulation is a powder formulation, suitable to add to a liquid (such as water, sparkling water, carbonated liquid, juice or the like) in order to make a tasty instant drink. The powder form may be in discreet pre-measured units, such as sachets, envelopes, packets or the like. Another formulation is a sorbet which can be eaten in place of a liquid drink. While a consumer may consume all the dosages as sorbets, it is recognized that not everyone may enjoy eating this much sorbet, so in some embodiments, the various dosage forms may be mixed during a dosage regime: sometimes the consumer may have a beverage, sometimes a gel or sorbet.

The premeasured units may be packaged together in multiples. It is envisioned that the consumer may consume two doses per day, so a container may have a plurality of dosages, or a single dosage. For example, the container may conveniently contain any predetermined number of dosages, for example, a single dose, a day's supply, one or more weeks supply such as 14, 28, or more. Alternatively other multiples could be used: 10, 20, or so on. A month's package may contain 60 doses and multiple moths may also be sold.

The premeasured powder formulations may be packaged in a container which may take any conventional form. For example the premeasured doses may be in a jar, bottle, tin box, pot, or the like which contains the plurality of premeasured dosages, such as a 30-day supply, a 60-day supply.

Alternatively, the powder may be in bulk in a single container and the consumer can measure a convenient amount to add to liquid, such as water or juice or the like. A measuring device may optionally form another part of this packaged kit.

For a squeezy gel, the formulation is packaged in a suitable squeeze container. The containers may be sold separately or in multipacks.

For premade liquid formulations, such as a shot, the formulation is in a suitable container. The containers may be sold individually or in a group, such as a four- or six-pack or the like. It may have an easy-to-open top, or one which may be closed and re-opened.

For sorbet or other frozen type dosage forms, the frozen formulation is sold in either small single dosage ready to eat containers (which may include a disposable spoon or the like) or may be sold in a bulk container where the consumer scoops out the desired amount. The sorbet may also be shaped into an easy-to-eat-shape which does not require a container, such as a frozen bar on a stick, or the like.

The informational material may be part of the material used to package the doses. For example, if a capsule or tablet forms are packaged in a container which may be re-opened and closed, such as a jar, bottle, or pot, then the informational material may be printed on a label which is affixed to the outside of the container. Alternatively and/or additionally, the informational material may be on a separate insert which is placed in a box, envelope, or the like which holds the container.

Alternatively and/or additionally, the informational material need not be physically associated with the kit. For example, the informational material may be in the form of printed leaflets, flyers, advertising placards, or the like which is displayed in the proximity (preferably within one meter) of the kit. The informational material may be in a form which allows the potential consumer to take a printed material (such as a hand-out, flier, postcard or the like) or may merely impart information. The information may be provided to the customer through conventional marketing methods using a variety of media, such as though mass communication advertising (television/radio advertising, print advertising such as in magazines, internet marketing and advertising such as through web sites, social networking sites, and the like). In preferred embodiments, the consumer is informed about at least one benefit of Trp-containing hydrolysate.

Informational Material

The exact wording of the informational material is not a critical part of the invention, provided that it conveys at least one benefit selected from the following genera of benefits:
benefits of Trp-hydrolysate
storage instructions
recommended administration regimes
dates which are indicative of the product's shelf life (such as a “use-by” date or a “best-by” date or a “sell-by” date).

Some of benefits of Trp-hydrolysate include: an increased feeling of energy accompanying chronic usage; and increased energy which does not interfere with sleep patterns. A healthy person will experience a pleasant feeling of being energized, “buzzed”, and/or feeling mentally stimulated, “hyper”; feel that their ‘mind is racing’; and/or ‘impulsive/spontaneous’. Thus, the information may note that persons engaging in stressful tasks or those needing bursts of creative thinking, or high mental energy would particularly appreciate the Trp-hydrolysates.

Suggested populations of people who would benefit from dosings include: students, people involved in the creative arts, people whose professions require creative thinking or problem solving capabilities, people who feel under pressure to produce and those where thought processes are important. Non-limiting examples would include: engineers, writers, those in the advertising/sales/marketing industries, those in the entertainment industry, musicians, investigators, health care professionals such as nurses, emergency workers and physicians, researchers, salespersons, military and police personnel, and others.

Alternatively, the low dose Trp-peptides are suitable for people who would prefer to have a Trp-supplement as part of a food or drink which has a pleasant flavor and which consumed more than once per day.

The following non-limiting examples are presented to illustrate the invention.

### EXAMPLE 1

### Example 1

### Clinical Trial

Design and Treatment

The design was a randomized, double-blind, placebo-controlled, between-subjects. Each group had 30 participants. The treatment conditions were either

Placebo: Casein hydrolysate (primary milk protein hydrolysate; DSM Nutritional Products, Kaiseraugst, Switzerland) 0.52 g b.i.d was used to provide an intermediate amount of energy and total protein, in the placebo beverage, relative to the active treatments. It is appreciated from previous studies that casein hydrolysate is low in Trp and so will not raise serotonin synthesis.

LumiVida™ (DSM Nutritional Products, Kaiseraugst, Switzerland) is a hydrolysed, enzymatic digest of a dietary protein (hen egg lysozyme) manufactured by using a proprietary mix of enzymes to provide a high quality source of peptides. The resulting protein hydrolysate (LumiVida™) contains a guaranteed minimum quantity of bioactive Trp-containing peptides. The ratio of these TRP peptides to peptides containing the Large Neutral Amino Acids (LNAA: Valine, Isoleucine, Leucine, Tyrosine, Phenylalanine) is approx. 0.2. LumiVida™ was taken as a citrus-flavored non-nutritively (Acesulfame) sweetened beverage given as 0.5 g LumiVida™ twice per day (b.i.d., i.e. 1 g LumiVida™ per day, which contains in total approx. 70 mg Trp per day).

Participants were randomly allocated, stratified by age, to either the placebo supplement group (N=30) or the LumiVida™ (0.5 g b.i.d.) supplement group (N=30). Both treatments were supplied in sachets of powder; each of these was stirred into approx. 150 ml tap water, forming a suspension. Double-blind randomization was carried out by means of a label code associated with a specific participant ID number, whose meaning is known only to the supplier. Participants were allocated randomly to these numbers.

The first testing took place on the screening day (baseline, Day 0) Subsequently, participants were supplied with 38 supplements (2 per day for 19 days) in the form of sachets of powder to be dissolved in 150 ml cold water. Participants were instructed to start taking the supplement on Day 3, so that Days 1 and 2 could be used to provide a pair of baseline sleep diary days prior to treatment. After 19 days of treatment, participants came back on Day 22 (test Day 2 (same test battery)), following one morning supplement dose on the final test day (timing as for first test day

A single blood sample was taken on the baseline day, to establish pre-treatment levels of Trp and LNAA, for comparison with results at the end of treatment. On test Day 22, two blood samples were taken, i.e. before and after treatment, to determine whether fasting plasma Trp and Trp/LNAA levels were affected by the chronic treatment, and whether the single LumiVida™ (0.5 g) dose was effective in raising Trp/LNAA even after 19 days' treatment.

Results

59 female participants, aged 45-64 years (mean [SD]=53.9 [6.3]), completed pre- and post-treatment test sessions (Placebo N=30, LumiVida™ N=29). Although usually non-completers were replaced (treatment was stopped for 2 participants due to illness), one participant who failed to arrive for testing could not be replaced due to the end of feasible scheduling.

Main hypotheses: LumiVida™ would improve perceived energy levels.

Participants were asked to rate three times per assessment day various mental and physical sensations in a questionnaire (Mental and Physical Sensations (MAPS scale):
Three times at the baseline day (Day 0):

1. measurement at beginning of the day,

2. measurement 105 min later; and

3. measurement another 100 min later).
After 19 days LumiVida™ consumption (Day 22):

1. measurement at beginning of the day,

2. measurement 105 min later (90 min after the last placebo or treatment drink intake); and

3. measurement another 100 min later.

One factor of the MPAS scale was provisionally labeled “High Energy” after a Principal Component Analysis (PCA) was run (7.4% of variance, overall mean=3.08). Sensations of “high energy” were described using these terms: such as ‘buzzing/feel stimulated/hyper’; ‘mind is racing’; ‘impulsive/spontaneous’.

Effects on High Energy

Ratings of High Energy were moderate. The baseline levels (first measurement on Day 1 and Day 22) did not differ between treatment groups, 1-way ANOVA group effect, F(1, 57)<1, variance explained ηₚ²=0.007, NS; mean (SD): LumiVida™=3.03 (1.61), Control=3.29 (1.52).

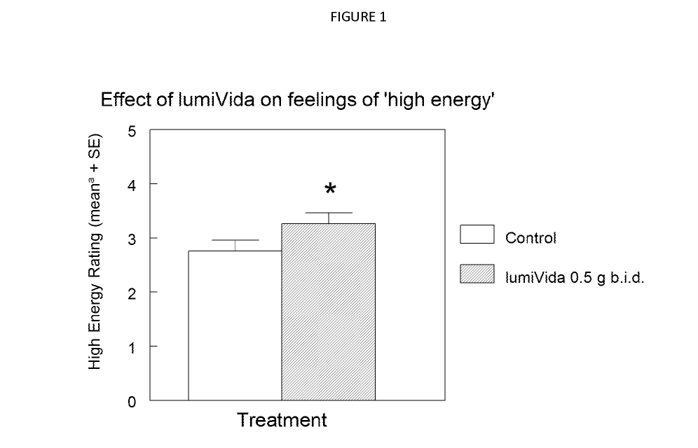

Treatment condition had a small but significant effect on energy levels on the final test day, with higher overall energy ratings following chronic LumiVida™ treatment than after Control treatment, adjusting for baseline levels, ANCOVA treatment effect, F(1, 54)=3.12, p<0.05 1-tail, ηₚ²=0.055 (FIG. 1).

Combined ratings of ‘high energy’ (feeling stimulated, buzzing, impulsive, spontaneous) over all three test applications at the final test day were higher after chronic treatment with LumiVida™ than Control. These ratings did not change over the course of the final test day, i.e. were unaffected by the final drink.

### EXAMPLE 2

### Raspberry Lemonade Lumivida Instant Beverage

| Ingredient | Grams |
|---|---|
| Per 480 ml water | |
| Sucrose | 14.4 |
| Citric Acid | 1 |
| Raspberry Flavor | 0.05 |
| Lemon Flavor | 0.05 |
| LUMIVIDA | 2 |
| Sucralose | 0.05 |
| TOTAL | 17.55 |

| INGREDIENT | |
|---|---|
| For 100 g powder | |
| Sucrose | 82.5 |
| Citric acid | 5.7 |
| Raspberry Flavor | 0.285 |
| Lemon Flavor | 0.285 |
| LUMIVIDA | 11.4 |
| Sucralose | 0.285 |
| TOTAL | 100 |

### EXAMPLE 3

### Blood Orange Flavored Ready-to-Consume Carbonated Drink

| Ingredient | Amount g/kg |
|---|---|
| Sucrose Granulated | 100.00 |
| Sodium Benzoate | 0.18 |
| Citric Acid | 2.50 |
| Ascorbic Acid | 0.20 |
| Blood Orange Flavor | 2.00 |
| Beta Carotene 10% CWS/S | 2.00 |
| (stock solution 1 mg/ml) | |
| Lumivida | 1.93 |
| Calcium D Pantothenate | 0.01004 |
| (B5) | |
| Pyridoxine Hydrochloride | 0.00200 |
| (B6) | |
| B12 0.1% WS | 0.00602 |
| Niacinamide (B3) | 0.02004 |
| Water De-ionized and | 891.15 |
| carbonated | |
| Total | 1000.00 |

Serving size: 200-300 ml

### EXAMPLE 4

### Berry Blend Shot

| Ingredient | Grams | % Juice |
|---|---|---|
| Apple concentrate | 30 | 18.5 |
| White grape concentrate | 20 | 8.3 |
| Red grape concentrate | 20 | 8.3 |
| LUMIVIDA | 8.33 | |
| Cranberry Concentrate | 7.5 | 5.1 |
| Blackcurrant Concentrate | 7.5 | 9.8 |
| Citric Acid | 3 | |
| Strawberry Flavor | 1 | |
| Stevia sweetener | 0.5 | |
| Water | 902.2 | |
| TOTAL | 1000 | 0.5 |

SERVING SIZE: 60

### EXAMPLE 5

### Fruit Shot

| | 0.5 g/serving | 1 g/serving |
|---|---|---|
| Material in g | LumiVida | LumiVida |
| Water | 985.680 | 973.380 |
| Sucralose | 0.400 | 0.400 |
| Lemon flavor | 0.800 | 0.800 |
| Raspberry flavor | 0.020 | 0.020 |
| Potassium sorbate | 0.000 | 0.000 |
| Lactic acid (45% w/w) to pH = 3.6 | 4.800 | 8.700 |
| LumiVida | 8.300 | 16.700 |
| Total | 1000.000 | 1000.000 |

Preparation:
Mix the dry ingredients
Mix the water with the Potassium sorbate and add the dry ingredients
Add the Lactic Acid solution and set on pH 3.6
Add the flavours
Fill into PET bottles
Pasteurisation 72° C. for 2 minutes

What is claimed is:

1. A method of marketing a hen egg lysozyme hydrolysate comprising providing a kit which comprises:
a) a low dose of a hen's egg lysozyme hydrolysate comprising Trp-containing di- and/or tri-peptides “Trp-containing protein hydrolysate”) characterized in that the Trp-containing protein hydrolysate has a Trp/Large Neutral Amino Acid (LNAA) ratio greater than 0.15 and which provides 10- to 100 mg Trp per dose;
b) instructions for use which inform a prospective user that the dose a) should be administered multiple times per day for an extended period of time, such that the person receives 60-200 mg Trp per day;
c) optionally, additional information.

2. A method according to claim 1 wherein a single dose comprises 300-600 mg Trp-hydrolysate.

3. A method according to claim 1 wherein the kit comprises additional material which is informational material.

4. A method according to claim 3 wherein the informational material is not physically associated with the kit.

5. A method according to claim 4 wherein the informational material is in the form of printed leaflets, flyers, or advertising placards, which is displayed in the proximity of the kit.

6. A method according to claim 1 wherein the information is provided to the customer through mass communication advertising selected from the group consisting of television/radio advertising, print advertising, internet marketing and advertising, social network sites, and web sites.

7. A method according to claim 1 wherein the informational material conveys at least one of the following:
benefits of Trp-hydrolysate
storage instructions
recommended administration regimes
dates which are indicative of the product's shelf life

8. A method according to claim 1 wherein said kit comprising at least one of the following dosage forms of the Trp-hydrolysate:
powder;
liquid;
gel; or
sorbet.

9. A method according to claim 8 wherein the powder is packaged in discreet pre-measured units, selected from the group consisting of: sachets, envelopes, and packets.
